(19) United States
(12) Patent Application Publication
(10) Pub. No.: US 2012/0061194 A1
(43) Pub. Date: Mar. 15, 2012

(54) SHOCK ABSORBER

(75) Inventor: Chun Sung YU, Iksan-si (KR)

(73) Assignee: MANDO CORPORATION

(21) Appl. No.: 13/226,899

(22) Filed: Sep. 7, 2011

(30) Foreign Application Priority Data
Sep. 7, 2010 (KR) 10-2010-0087460

(51) Int. Cl. F16F 9/48; F16F 9/16; F16F 9/06

(52) U.S. Cl. 188/288

(57) ABSTRACT

A shock absorber includes: a working tube having a first internal diameter portion and a second internal diameter portion, an internal diameter of which is smaller than an internal diameter of the first internal diameter portion; a piston valve having an external diameter corresponding to the internal diameter of the first internal diameter portion and sliding along the inner surface of the first internal diameter portion; and a damping piston having an external diameter corresponding to the internal diameter of the second internal diameter portion and sliding along the inner surface of the second internal diameter portion. The second internal diameter portion is disposed at a lower portion of the working tube, such that it interacts with the damping piston when a full bump of the shock absorber occurs. The second internal diameter portion includes a slit that is formed in a longitudinal direction and faces the damping piston.

### CROSS-REFERENCE(S) TO RELATED APPLICATION

This application claims priority of Korean Patent Application No. 10-2010-0087460, filed on Sep. 7, 2010, in the Korean Intellectual Property Office, which is hereby incorporated by reference in its entirety.

### BACKGROUND OF THE INVENTION

1. Field of the Invention

The present invention relates to a shock absorber, and more particularly, to a shock absorber having an improved structure suitable for absorbing and reducing shock in the full bump of the shock absorber.

2. Description of the Related Art

In general, a shock absorber for a vehicle refers to a vibration absorbing/reducing device that is installed between an axle and a vehicle body to provide a more comfortable ride by absorbing vibration or shock transferred from a road to the axle when a vehicle is driving. The inside of the shock absorber is filled with gas and oil so as to increase the damping force of the shock absorber. Typically, hydraulic shock absorbers filled with oil have been widely used.

A shock absorber includes a cylinder having a working tube filled with a working fluid such as oil, a piston valve sliding within the working tube, and a piston rod connected to the piston valve and extending to the outside of the cylinder. The piston rod and the cylinder are connected to a vehicle body and an axle, respectively, and operate while performing a relative motion. The piston valve is operated by the working fluid to generate a damping force.

Big shock and noise may be generated in the proximity of a full bump of a vehicle or a shock absorber. To prevent such a problem, a conventional shock absorber uses a bump rubber. A bump rubber is made of rubber or urethane and is disposed between the outside of a cylinder, especially an upper mount, and an upper cap of the cylinder. A reaction force is generated when the bump rubber is pressed between the upper mount and the upper cap in a full bump. Therefore, big noise may be generated and the durability of the bump rubber may be lowered, depending on the degree of pressing and/or contact conditions. These problems may be overcome by making a bump rubber of a high quality material. In this case, however, the production cost increases and the cost performance is unsatisfactory.

### SUMMARY OF THE INVENTION

An aspect of the present invention is directed to a shock absorber that further includes a mechanism of reducing shock hydraulically, separately from a piston valve, thereby effectively absorbing and reducing shock in the full bump of the shock absorber.

According to an embodiment of the present invention, a shock absorber includes: a working tube having a first internal diameter portion and a second internal diameter portion, an internal diameter of which is smaller than an internal diameter of the first internal diameter portion; a piston valve having an external diameter corresponding to the internal diameter of the first internal diameter portion and sliding along the inner surface of the first internal diameter portion; and a damping piston having an external diameter corresponding to the internal diameter of the second internal diameter portion and sliding along the inner surface of the second internal diameter portion.

The second internal diameter portion may be disposed at a lower portion of the working tube, such that it interacts with the damping piston when a full bump of the shock absorber occurs. The damping piston may include a through-hole that allows a fluid flow when the damping piston is located at the second internal diameter portion.

The second internal diameter portion may be disposed at a lower portion of the working tube in which the full bump of the shock absorber occurs, and a slit facing the damping piston may be formed in the second internal diameter portion in a longitudinal direction.

The first internal diameter portion may be formed by the inner surface of the cylinder tube, and the second internal diameter portion may be formed by the inner surface of a hollow tube inserted at a lower portion of the working tube. At a lower portion of the first internal diameter portion, a body valve may be installed to generate a damping force together with the piston valve. A base shell enclosing the working tube may be connected to the body valve. The piston valve and the damping piston may be spaced apart by a spacer and commonly connected to a single piston rod.

### BRIEF DESCRIPTION OF THE DRAWINGS

FIG. 1 is a sectional view showing a shock absorber according to an embodiment of the present invention.

FIG. 2 is a sectional view taken along line I-I of FIG. 1.

FIG. 3 is an enlarged sectional view showing a part of the shock absorber of FIG. 1 in a normal operation state.

FIG. 4 is an enlarged sectional view showing a part of the shock absorber of FIG. 1 in a damping operation state in a full bump.

<Reference Numerals>

| | |
|---|---|
| 10: working tube | 12: hollow tube |
| 20: piston rod | 30: piston valve |
| 40: base shell | 50: body valve |
| 60: damping piston | 62: through-hole |
| 63: Teflon tape | 121: slit |

### DETAILED DESCRIPTION OF EXEMPLARY EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. In the drawings, the widths, lengths and thicknesses of elements may be exaggerated for clarity. Like reference numerals refer to like elements throughout this disclosure.

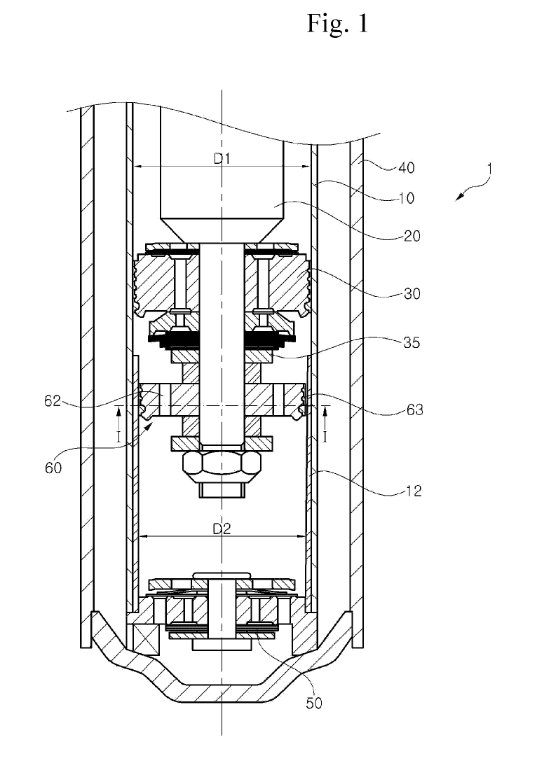

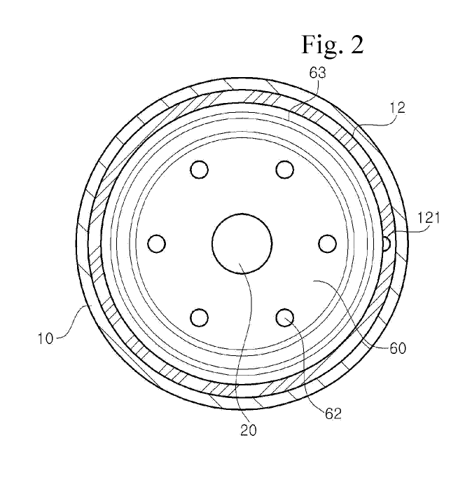

FIG. 1 is a sectional view showing a shock absorber according to an embodiment of the present invention, and FIG. 2 is a sectional view taken along line I-I of FIG. 1.

As shown in FIG. 1, a shock absorber 1 according to an embodiment of the present invention includes a working tube 10 filled with oil, a piston rod 20 inserted into the working tube 10 and provided to be movable vertically within the working tube 10, a piston valve 30 connected to the piston rod 20, and a base shell 40 enclosing the working tube 10. Like the piston valve 30, a body valve 50 is installed at a lower end of the working tube 10 to generate a damping force according to the operation of the shock absorber 1. Although not shown, a rod guide is installed at an upper end of the working tube 10 and the base shell 40, such that the piston rod 20 is supported vertically slidably.

A lower portion of the base shell 40 is connected to the body valve 50. The inside of the base shell 40 is filled with oil and gas. The vertical movement of the piston valve 30 causes oil to flow from the inside of the base shell 40 to the inside of the working tube 10 through the body valve 50, or causes oil to flow from the inside of the working tube 10 to the inside of the base shell 40 through the body valve 50. Accordingly, a change in internal pressure of the working tube 10 according to the vertical movement of the piston valve 30 is compensated.

While being connected to the piston rod 20, the piston valve 30 moves up and down within the working tube 10 to absorb and reduce shock or vibration applied to the vehicle. To this end, the piston valve 30 partitions the inside of the working tube 10 into an upper rebound chamber and a lower compression chamber. Due to a valve structure and vertical movement of the piston valve 30, the piston valve 30 causes oil to selectively flow to the rebound chamber and the compression chamber. That is, if the piston valve 30 rises according to a rebound cycle, a rebound passage of the piston valve 30 is opened and a working fluid of the rebound chamber flows into the compression chamber. If the piston valve 30 falls according to a compression cycle, a compression passage of the piston valve 30 is opened and a working fluid of the compression chamber flows into the rebound chamber. During this operation, the piston valve 30 generates a damping force. In a similar manner to the piston valve 30, the body valve 50 generates a damping force to reduce vibration by generating a resistance with respect to oil flowing through its own passage.

According to the embodiment of the present invention, a hollow tube 12 is fitted into an internal lower portion of the working tube 10. Accordingly, a first internal diameter portion and a second internal diameter portion are formed in the working tube 10. The first internal diameter portion has a first internal diameter D1 defined by the inner surface of the working tube 10, and the second internal diameter portion has a second internal diameter D2 defined by the inner surface of the hollow tube 12. The second internal diameter D2 is smaller than the first internal diameter D1.

Since the piston valve 30 has an external diameter corresponding to the internal diameter D1 of the first internal diameter portion, it slides along the inner surface of the working tube 10. Accordingly, the piston valve 30 may generate a damping force by allowing an oil flow between the rebound chamber and the compression chamber.

The shock absorber 1 according to the embodiment of the present invention includes a damping piston 60. As shown in FIGS. 1 and 2, the damping piston 60 has an external diameter corresponding to the internal diameter of the second internal diameter portion, that is, the internal diameter of the hollow tube 12. Therefore, the damping piston 60 may slide along the second internal diameter portion, that is, the inner surface of the hollow tube 12. The piston valve 30 and the damping piston 60 are commonly connected to the piston rod 20, and a spacer 35 separates the upper piston valve 30 from the lower damping piston 60.

As described above, the second internal diameter portion defined by the inner surface of the hollow tube 12 is disposed with a predetermined length at a position at which shock can be reduced by interaction with the damping piston 60 in the full bump of the shock absorber 1, that is, a lower position of the working tube 10. In addition, the working tube 10 includes a plurality of through-holes 62 passing through the working tube 10 in a vertical direction. The plurality of through-holes 62 acts as a main factor that generates degressive characteristic at a low speed. For example, a Teflon band 63 is installed on an outer circumferential surface of the damping piston 60 in order for smooth sliding with the inner surface of the second internal diameter portion, that is, the inner surface of the hollow tube 12.

As shown in FIG. 2, at least one slit 121 is formed in the inner surface of the second internal diameter portion, that is, the inner surface of the hollow tube 12, in a longitudinal direction, such that it faces the outer circumferential surface of the damping piston 60. The slit 121 serves to generate different reaction forces according to a stroke of the shock absorber 1. The length of the slit 121 may be determined considering reaction characteristic, and the cross-sectional area of the slit 121 may be different according to the stroke.

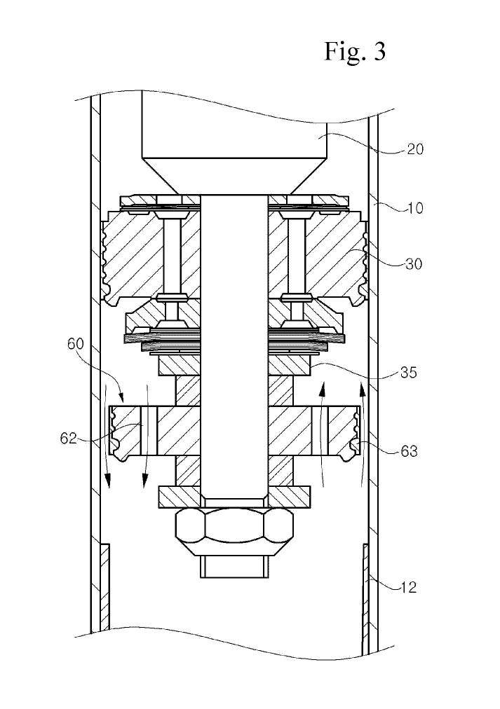

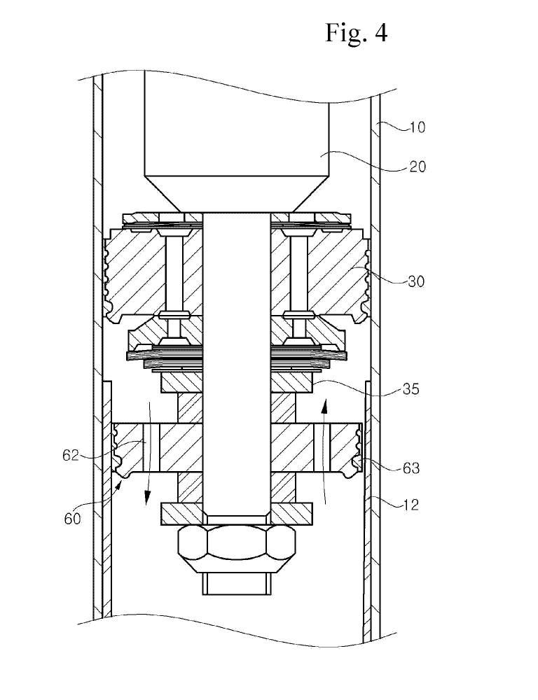

FIGS. 3 and 4 are views explaining a normal operation state and a damping operation state in full dump in the shock absorber according to the embodiment of the present invention.

Referring to FIG. 3, the damping piston 60 is disposed within the first internal diameter portion having the first internal diameter D1 defined by the inner surface of the working tube 10, together with the piston valve 30. At this time, a large gap exists between the outer circumference of the damping piston and the working tube 10. Therefore, oil flows through the gap and the through-holes 62 of the damping piston 60, without large resistance. At this time, the shock absorber 1 performs a normal rebound and compression operation.

Referring to FIG. 4, the piston valve 30 and the damping piston 60 further fall together. Accordingly, it becomes a state in which the damping piston 60 slides along the inner surface of the hollow tube 12, that is, the second internal diameter portion. In this state, a shock caused by full bump may occur. However, since no gas exists between the damping piston 60 and the working tube 10, a reaction force that pushes up the damping piston 60 is increased. Therefore, a shock caused by the full bump may be considerably reduced. At this time, only a small amount of oil flows from the lower portion of the damping piston 60 to the upper portion of the damping piston 60 through the plurality of through-holes 62 formed in the damping piston 60.

According to the shock absorber of the present invention, the second internal diameter portion having an internal diameter smaller than the first internal diameter portion is provided within the working tube having the first internal diameter portion allowing the sliding movement of the piston valve, and the damping piston is provided such that it is slidably moved in the second internal diameter portion. Therefore, the working tube may replace the conventional bump rubber or may supplement the problems of the conventional bump rubber. In addition, the shock in the full bump may be reduced with reliability. In particular, the present invention can remove the use of the bump rubber that reduces shock in the full bump but causes noise during a compression and decompression process. Therefore, the shock absorber of the present invention can operate more quietly. Moreover, the shock absorber of the present invention is cost-effective because there is no rising cost problem caused when the bump rubber is made of a high quality material in order to remove noise.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A shock absorber comprising:
a working tube having a first internal diameter portion and a second internal diameter portion, an internal diameter of the second internal diameter portion being smaller than an internal diameter of the first internal diameter portion;
a piston rod slidably supported by a rod guide disposed at an upper end of the working tube, and reciprocating in a vertical direction within the working tube;
a base shell provided to enclose the working tube;
a body valve connected to a lower end of the working tube at a lower portion of the base shell;
a piston valve connected to the piston rod within the working tube to partition the inside of the working tube into an upper rebound chamber and a lower compression chamber; and
a damping piston disposed under the piston valve, spaced apart from the piston valve, and connected to the piston rod,
wherein the piston valve has an external diameter corresponding to the internal diameter of the first internal diameter portion and slides along the inner surface of the first internal diameter portion,
the damping piston has an external diameter corresponding to the internal diameter of the second internal diameter portion and slides along the inner surface of the second internal diameter portion, and
the second internal diameter portion extends from the lower end of the first internal diameter portion to the proximity of the body valve disposed at the lower end of the working tube, such that the second internal diameter portion interacts with the damping piston when a full bump of the shock absorber occurs.

2. The shock absorber of claim 1, wherein the damping piston comprises a through-hole that allows a fluid flow when the damping piston is located at the second internal diameter portion.

3. The shock absorber of claim 2, wherein the through-hole is entirely opened to allow a fluid to flow without interruption.

4. The shock absorber of claim 3, wherein the through-hole is formed plurally, and the plurality of through-holes are arranged at regular intervals along a virtual circle centering on the piston rod.

5. The shock absorber of claim 1, wherein the second internal diameter portion comprises a slit that is formed in a longitudinal direction and faces the damping piston.

6. The shock absorber of claim 1, further comprising a spacer disposed between the piston valve and the damping piston and connected to the piston rod in order to separate the piston valve from the damping piston.

7. The shock absorber of claim 1, wherein a Teflon band is installed at an outer circumferential surface of the damping piston.

8. A shock absorber comprising:
a working tube having a first internal diameter portion and a second internal diameter portion, an internal diameter of the second internal diameter portion being smaller than an internal diameter of the first internal diameter portion;
a piston rod slidably supported by a rod guide disposed at an upper end of the working tube, and reciprocating in a vertical direction within the working tube;
a piston valve connected to the piston rod within the working tube to partition the inside of the working tube into an upper rebound chamber and a lower compression chamber; and
a damping piston disposed under the piston valve, spaced apart from the piston valve, and connected to the piston rod,
wherein the piston valve has an external diameter substantially equal to the internal diameter of the first internal diameter portion,
the damping piston has an external diameter substantially equal to the internal diameter of the second internal diameter portion, and
the second internal diameter portion is disposed in the proximity of the lower end of the first internal diameter portion, such that the second internal diameter portion interacts with the damping piston when the compression chamber disposed under the piston valve is compressed to a maximum level.

9. The shock absorber of claim 8, wherein the damping piston comprises a through-hole that allows a fluid flow when the damping piston is located at the second internal diameter portion.

10. The shock absorber of claim 9, wherein the through-hole is entirely opened to allow a fluid to flow without interruption.

11. The shock absorber of claim 10, wherein the through-hole is formed plurally, and the plurality of through-holes are arranged at regular intervals along a virtual circle centering on the piston rod.

12. The shock absorber of claim 8, wherein the second internal diameter portion comprises a slit that is formed in a longitudinal direction and faces the damping piston.

13. The shock absorber of claim 8, further comprising a spacer disposed between the piston valve and the damping piston and connected to the piston rod in order to separate the piston valve from the damping piston.

14. The shock absorber of claim 8, wherein a Teflon band is installed at an outer circumferential surface of the damping piston.
